(19) United States
(12) Patent Application Publication
(10) Pub. No.: US 2026/0246662 A1
(43) Pub. Date: Aug. 20, 2026

(54) CONFIGURING A UE FOR MULTICAST RECEPTION

(71) Applicant: CANON KABUSHIKI KAISHA, Tokyo (JP)

(72) Inventors: Yacine EL KOLLI, RENNES (FR); Pierre VISA, RENNES (FR); Walaa SAHYOUN, RENNES (FR)

(21) Appl. No.: 18/992,905

(22) PCT Filed: Jul. 10, 2023
(86) PCT No.: PCT/EP2023/068978

§ 371 Date: Jan. 9, 2025

(30) Foreign Application Priority Data
Jul. 13, 2022 (GB) 2210307.1

(51) Int. Cl. H04L 12/18; H04W 76/27; H04W 76/40

(52) U.S. Cl. CPC H04L 12/189; H04L 12/185; H04W 76/27; H04W 76/40

(57) ABSTRACT

A method for configuring a User Equipment, UE, of a wireless communication system for multicast reception, where the UE has previously joined a multicast session, is disclosed. The method at the UE operating in a non-connected Radio Resource Control, RRC, state (such as a RRC_INACTIVE state) comprises: receiving a notification indicating the multicast session has been activated; sending a MBS configuration request message for requesting configuration information for the reception of multicast data; receiving a MBS configuration message including configuration information for configuring the UE for reception of multicast data. A method at the base station is also disclosed.

### FIELD OF THE INVENTION

The present invention generally relates to configuring or setting up a User Equipment, UE, of a wireless communication system for multicast reception and particularly to configuring or setting up multicast reception in non-connected RRC state (e.g. RRC_INACTIVE state), including the multicast Multicast/Broadcast Service (MBS) Radio Bearer(s), MRB(s).

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations.

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems based on IEEE 802.11 standards, such as Wi-Fi.

Among the requirements for 5G NR, there are service requirements related to multicast and broadcast service, abbreviated as MBS.

For broadcast communication service, the same service and the same specific content data are provided simultaneously to all UEs in a geographical area (i.e. all UEs in the broadcast service area are authorized to receive the data). A broadcast communication service is delivered to the UEs using a broadcast session. For multicast communication service, the same service and the same specific content data are provided simultaneously to a dedicated set of UEs (i.e., not all UEs in the multicast service area are authorized to receive the data). A multicast communication service is delivered to the UEs using a multicast session.

The support of multicast/broadcast techniques enable the network to operate in a more efficient manner than unicast. The identified use cases that could benefit from this MBS feature include public safety and mission critical, V2X applications, IPTV, live video, software delivery over wireless and IoT applications. 3GPP started to build functional support of MBS in 5G NR with Release 17.

In 5G NR, Radio Resource Control (RRC) protocol operates in the control plane between a UE and a base station (gNB), and provides 3 different states for a UE as defined in the 3GPP specifications TS 38.331: RRC_CONNECTED, RRC_INACTIVE, and RRC_IDLE states. At power up, a UE is in RRC_IDLE state, and the UE changes to RRC_CONNECTED state upon an RRC connection establishment with a gNB. If the RRC connection is released then the UE changes back to RRC_IDLE state. When in RRC_CONNECTED state, the RRC connection can be suspended by the gNB, and the UE moves to RRC_INACTIVE state. When the UE is in RRC_INACTIVE state it cannot communicate with the 5G system, but both the gNB and the UE keep track of the RRC connection context. Thus, the transition back to the RRC_CONNECTED state from the RRC_INACTIVE state is faster than the RRC connection establishment from RRC_IDLE to RRC_CONNECTED state.

With the 3GPP Release 17, the reception of MBS broadcast by a UE is allowed when the UE is in RRC_IDLE, RRC_INACTIVE, or RRC_CONNECTED state, and the reception of MBS multicast is allowed when the UE is in RRC_CONNECTED state only. For the Release 18, the plan is to further allow the MBS multicast reception when the UE is in RRC_INACTIVE state. See, for example, 3GPP RP-213568 entitled “New WID: Enhancements of NR Multicast and Broadcast Services” submitted by CATT and entitled (3GPP TSG RAN Meeting #94-e, source CATT), section 3. The objective is to enable a large density of UEs to be receiving multicast data from one cell. Indeed, having UEs in

RRC_INACTIVE state leads to a downsize in the control plane footprint of the overall UEs, and thus allows the gNB to handle more UEs. Besides, to always keep UEs in RRC_CONNECTED state is not power efficient. As a result, the advantages of also supporting multicast for UEs in RRC_INACTIVE state have been recognized.

In Release 17, the MBS multicast session follows state transitions as defined in 3GPP TS 23.247 v17.3.0, FIGS. 4.3-1. The 5G nodes involved in MBS session management are described in clause 5.1 “General Architecture” of TS 23.247 v17.3.0. In this document “session” always refers to “MBS session”.

The session management procedures include session creation (7.1.1.2 or 7.1.1.3 of TS 23.247), session activation (7.2.5.2 of TS 23.247), session establishment and join (7.2.1.3 of TS 23.247).

At start the session does not exist. The session is created on demand of the AF (Application Function). As part of the creation process, the MBS session identifier is allocated, a multicast service area is defined and the session is announced to UEs in the service area. The multicast service area is defined in 3GPP TS 22.146 version 17.0.0, clause 3 “Definitions”. The multicast service area is defined per multicast service. One multicast service can start multiple multicast sessions. A multicast service area can be as big as a PLMN (Public Land Mobile Network) coverage area or less.

Once the session is created, the first UE to send a join request to that session will trigger the session establishment toward the NG-RAN (gNB(s) included in the multicast service area). Subsequent join request from other UEs will not trigger the session establishment. The session establishment procedure includes PDU session establishment by the UE, session join request by the UE (associating the PDU session to the MBS session), resources reservation from the core to the NG-RAN for the delivery of MBS data for the first join request.

Also once the session is created, the MB-SMF (MBS Session Management Function) can be triggered to activate the session. The trigger condition reflects the availability of the multicast data from the application. The session activation procedure includes NG-RAN resource reservation.

It is only when both the session is activated and the MBS session is established that the NG-RAN will configure the UE for the reception of multicast data.

The launch of the processes of session activation and session establishment answers to different triggers: for session activation, the trigger is the availability of the multicast data from the application and for session establishment, the trigger is the presence of at least one UE in the service area that sends a join request to the multicast session.

The establishment of a MBS session in a UE is performed when the UE is in RRC_CONNECTED state. It is possible that a gNB may then decide to switch the UE to RRC_INACTIVE state before the MBS multicast data are available through the session activation. As a result, when the session is activated the NG-RAN (at least one gNB) will have to notify and configure the UEs that have joined the session but are in RRC_INACTIVE state.

The current version of the specifications does not provide a procedure to notify or configure a UE in RRC_INACTIVE state. UE in RRC_INACTIVE state is not supposed to receive any data from applications and have limited access to control plane.

In Release 17, some mechanism was proposed to handle the case of broadcast reception in RRC_INACTIVE state. Document TS 38.300 version 17.0.0, in clause 16.10.6.2 explains the use of MCCH (MBS Control Channel) by the gNB to provide the configuration to UEs in any RCC state including the RRC_INACTIVE state. Indeed the MCCH channel is accessible to UEs RRC_INACTIVE state and it is well adapted to send notifications and configuration parameters. However, the MCCH is indeed accessible to all UEs without restriction which for MBS multicast services represents a security breach since the access to the multicast data is subject to prior authorization for each UE during the join procedure. The multicast configuration should be available only to UEs who have acquired the proper authorization during the join procedure.

As part of on-going discussions for Release 18, document S2-2200599 proposes to switch the UE back into the RRC_CONNECTED state, perform the configuration and switch again the UE to RRC_INACTIVE state. While this solution seems functional, the purpose of offloading the gNB in case of large density of UEs by having UEs in the RRC_INACTIVE state may not be achieved due to the additional signalling and other resources required to switch to the RRC_CONNECTED state in order to configure the UE and then switch back again to the RRC_INACTIVE state.

Accordingly, it is desirable to provide at least one solution to enable a UE, which has previously joined a multicast session, to be configured to receive multicast data when the multicast session is activated whilst staying in RRC_INACTIVE state.

### SUMMARY

In accordance with a first aspect of the present invention, there is provided a method for configuring a User Equipment, UE, of a wireless communication system for multicast reception, the UE having previously joined a multicast session, the method at the UE operating in a non-connected Radio Resource Control, RRC, state comprising: receiving a notification indicating the multicast session has been activated; sending a MBS configuration request message for requesting configuration information for the reception of multicast data; receiving a MBS configuration message including configuration information for configuring the UE for reception of multicast data.

In an example, the non-connected RRC state is a RRC_INACTIVE state.

The notification may be a paging message (e.g. group paging message) sent by a base station and may include a MBS session id identifying the activated multicast session and MBS session activation cause for indicating the multicast session has been activated (e.g. by the core network)

In an example, the MBS configuration request message includes an identifier for identifying the activated multicast session, such as a Temporary Mobile Group Identity, TMGI or MBS session id.

The configuration information may include configuration information of at least one MBS radio bearer (MRB).

In accordance with a second aspect of the present invention, there is provided a method at a base station controlling a cell on which one or more User Equipment, UE, are camping as recited in claim 13 of the accompanying claims.

Thus the UE is kept in non-connected RRC state (e.g. RRC_INACTIVE state) during the whole process and it is able to acquire the necessary configuration for multicast data reception as soon as it is available.

By sending a notification indicating the multicast session has been activated on MBS session activation, the UE can determine that the notification concerns MBS session activation and this helps to prevent UEs from automatically initiating a RRC resume procedure and switching to the RRC_CONNECTED state. Furthermore, by configuring the UE in the RRC_INACTIVE state after notification that the multicast session has been activated, requiring the UE to switch to the RRC_CONNECTED state at the activation of the multicast MBS session can be avoided which means the number of UEs in the RRC_CONNECTED state can be reduced with a resulting reduction in congestion at the gNB. Furthermore, in an example, where the notification sent by the base station is a group paging message, using a group paging message is simpler than having to page individually all UEs, but a corrupted UE may pretend to have joined the session earlier to tamper with the multicast session. By having the MBS configuration request/response protocol run by the UE to request the MBS configuration, the gNB is able to perform an access authorization check and may deny the configuration to a corrupted UE (e.g. by not responding to the MBS configuration request message sent by the corrupted UE).

The notification may be a group paging message, sent by a base station and received at the UE, and which group paging message may include an identifier for identifying the activated multicast session and/or information for indicating the multicast session has been activated. The information for indicating the multicast session has been activated may include MBS session activation cause. In an example, the MBS configuration request message is a RRCResumeRequest message and the MBS configuration message is a RRCRelease with suspend configuration message. Sending the RRCRelease with suspend configuration message after receiving the MBS configuration request message from a UE in a non-connected RRC state (e.g. RRC_INACTIVE), helps prevent the UE from initiating a RRC resume procedure and switching to the RRC_CONNECTED state and so keeps the UE in the non-connected RRC state using a simple procedure (i.e. without the need for lots of signalling) whilst still configuring the UE for the activated MBS session.

In accordance with a third aspect of the present invention, there is provided an apparatus for a User Equipment (UE) device/apparatus as recited in claim 25 of the accompanying claims.

In accordance with a fourth aspect of the present invention, there is provided an apparatus for a base station as recited in claim 26 of the accompanying claims.

Further example features of the invention are described in other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by a processing unit, cause the processing unit to carry out the method of any aspect or example described above and a computer readable storage medium carrying the computer program.

### BRIEF DESCRIPTION OF THE DRAWINGS

Different aspects of the invention will now be described, by way of example only, and with reference to the following drawings in which:

FIG. 1 is a schematic diagram illustrating a first example wireless communication system in which the present invention may be implemented according to one or more embodiments of the invention;

FIG. 2 illustrates a block schematic diagram of an example configuration of a UE in which the present invention may be implemented according to one or more embodiments of the invention;

FIG. 3 illustrates a block schematic diagram of an example configuration of a base station in which the present invention may be implemented according to one or more embodiments of the invention;

FIG. 4 is a flowchart showing the RRC connection states and transitions for a UE in 5G NR systems;

FIGS. 5a and 5b are schematic and simplified diagrams of example message flows and which together illustrate an example scenario of MBS session evolution from creation to activation;

FIG. 6 is a schematic and simplified diagram of an example message flow in accordance with an embodiment of the invention;

FIG. 7 is a flow chart illustrating an example method executed by a UE according to an example of an embodiment of the invention;

FIG. 8 is a flow chart illustrating an example method executed by a gNB according to an example of an embodiment of the invention;

FIG. 9 is a flow chart illustrating an example method executed by a UE according to an embodiment of the invention;

FIG. 10 is a flow chart illustrating an example method executed by a gNB according to an embodiment of the invention.

### DETAILED DESCRIPTION

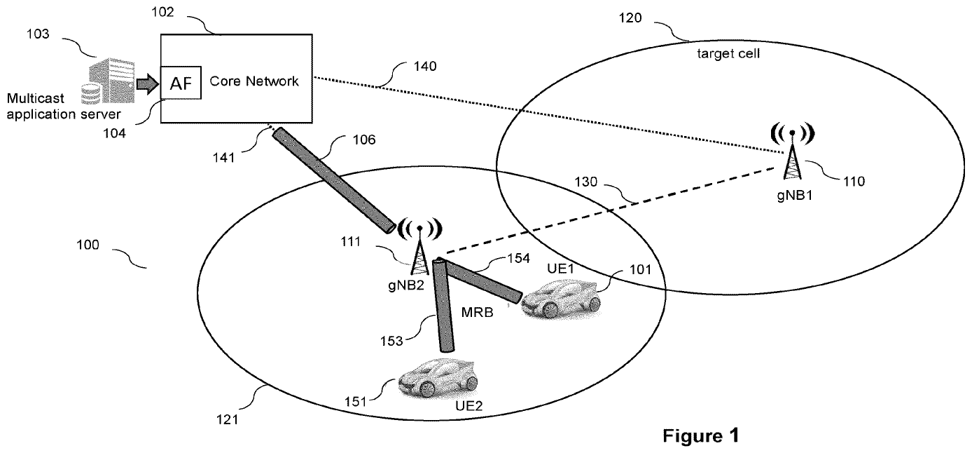

FIG. 1 illustrates an example wireless communication system 100, in particular a mobile radio communication system such as a fifth-generation (5G) New Radio (NR) system supporting multicast and broadcast service (MBS). Although in the following description, embodiments and examples of embodiments of the present invention will be described with respect to a 5G NR system, it will be appreciated that it is not intended that the present invention is limited to 5G NR systems and may be used in any wireless communication systems supporting MBS or similar service.

The system 100 comprises a User Equipment (UE) 101 (or 151), which may be for instance in or part of a vehicle, served by a base station 110 to communicate with a core network, such as the 5G core network 102. The UE may be any wireless device, such as a wireless communication device or apparatus or terminal, IoT device, Machine Type Communication (MTC) device, Device to Device (D2D) terminal, user device (e.g. smart phone, laptop, mobile phone, tablet, camera, game console, wearable device), capable of wireless communication with one or more core networks via one or more Radio Access Networks. The base station 110 is a network node which provides an access point to the core network for a UE and is part of the Radio Access Network (RAN) composed of the base stations 110, and 111. In NR, base stations are referred to as next-generation Node Bs (gNBs), the RAN is a Next Generation (NG) RAN and the core network is referred to as the 5GC. In the following, the terms RAN node, base station and gNB will be used interchangeably. The base stations 110 and 111 are interconnected by means of the Xn interface (specified in the 3GPP document TS 38.423) implemented on the wired or wireless link 130. Each base station is connected to the core network 102 by means of the NG interface (specified in the 3GPP document TS 38.413) implemented on the wired or wireless links 140 and 141.

Each of these base stations controls one or multiple cells. For instance, the base station 110 controls the cell 120, and the base station 111 controls the cell 121. A cell is a geographical area of a radio network defined by the frequency used in the cell to transmit data. The cell can be uniquely identified by a UE from an identification that is broadcasted over a geographical area. Each base station 110, 111 can serve several UEs like the UE 101 or UE 151. Once a UE has established a RRC connection with a base station (as discussed below), the base station, to which the UE is connected, is referred to as the serving base station or source base station of the UE and the cell which is controlled by the serving base station, and on which the UE camps, is referred to as the serving cell. The interface between a gNB and a UE is the Uu interface using the protocol sublayers SDAP (Service Data Adaptation Protocol), PDCP (Packet Data Convergence Protocol), RLC (Radio Link Control), MAC (Medium Access Control), PHY (Physical) in the user plane, and the protocol sublayers RRC (Radio Resource Control), PDCP, RLC, MAC, PHY in the control plane.

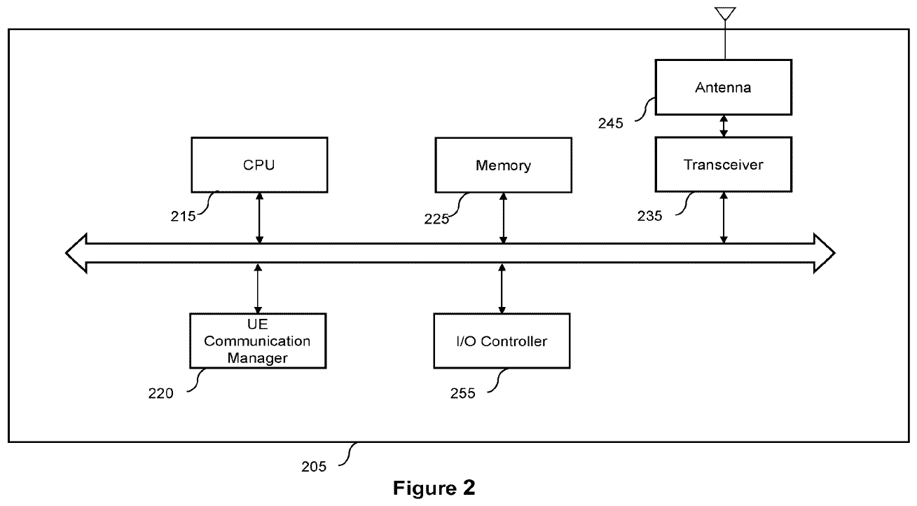

FIG. 2 illustrates a block diagram of a UE device 205, like the UE 101 or UE 151 in the FIG. 1, in which the present invention may be implemented according to one or more embodiments of the invention. The UE includes components for transmitting and receiving communications, including a UE communication manager 220, a I/O controller 255, a transceiver 235, a set of antennas 245, memory 225, and a processor (CPU: Central Processing Unit) 215. All these elements communicate with each other.

Memory 225 includes RAM (Random Access Memory), ROM (Read Only Memory), or combination of both or as a non-limiting example a mass storage device such as a disk or a Solid-State Drive. Basic Input Output System (BIOS) Instructions may be stored within the memory 225.

The processor 215 is configured to execute machine readable instructions. Execution of these machine-readable instructions causes the UE to perform various functions. These functions may be related to transmission or to interaction with peripheral devices like for instance a keyboard, a screen, a mouse, etc. (not shown in FIG. 2). The processor may run an operating system like for instance, iOS, windows, Android, etc., The processor 215 may be a single processor or may comprise two or more processors carrying out the processing required for the operation of the UE 205. The number of processors and the allocation of processing functions to the processors is a matter of design choice for a skilled person.

The I/O controller 255 allows these interactions with external peripherals by providing the hardware required and by managing input and output signals.

The transceiver 235 is configured to provide bi-directional wireless communication with other wireless devices. For example, it provides the necessary modems and frequency shifters necessary to connect to one or more wireless networks, such as Wi-Fi, Bluetooth, LTE, 5G NR, etc . . . .

The radio communications use the antenna set 245 adapted to the spectrum of the frequency transposed signals, issued from the baseband modems. The antenna set 245 may be limited to one antenna, but preferably it contains several antennas, in order to provide beamforming capability.

UE communication manager 220 handles the communication establishment of the UE to a Radio Access Network, its control and its release. The UE regularly receives from the base station an indication of slots available for communication between the UE and base station. The UE then knows where in time and frequency it expects incoming data or must send its outgoing data, whether they belong to the control or data plane. In an example implementation, the UE communication manager 220 implements the Uu interface.

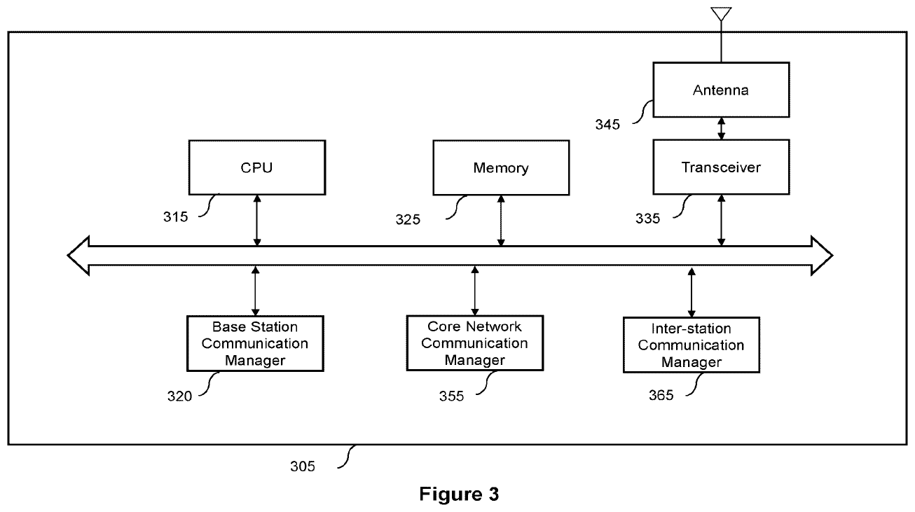

FIG. 3 illustrates a block diagram of a base station device 305, like the base stations or gNBs 110 and 111 in the FIG. 1, in which the present invention may be implemented according to one or more embodiments of the invention. The base station device 305 includes components for transmitting and receiving communications, including a Base Station communication manager 320, a Core Network communication manager 355, a transceiver 335, a set of antennas 345, memory 325, a processor (CPU) 315, and an Inter-Station communication manager 365. All these elements communicate with each other.

The Base Station communication manager 320 handles the communications with a plurality of UEs. It is responsible for the establishment, the control and the release of these communications. In an example implementation, the Base Station communication manager 320 implements the Uu interface. The Base Station communication manager 320 includes a scheduler that allocates time frequency slots to the different UE communications. Information regarding the schedule of these slots is regularly sent to the involved UEs.

The Core Network communication manager 355 manages communications of the base station with the core network. It may provide a standardized NG interface, as defined by the 3GPP standard, to support these communications.

The transceiver 335 is configured to provide bi-directional wireless communication with other wireless devices. These devices may be UEs, or even other base stations. The transceiver 335 provides the necessary modems and frequency shifters in order to connect to a large number of UEs simultaneously, using different frequency carriers, in Time Division Duplex (TDD) or in Frequency Division Duplex (FDD). The transceiver 335 is connected to the antenna set 345, that may be limited to one antenna, but preferably it contains several antennas, in order to provide beamforming capability.

Memory 325 includes RAM, ROM, or combination of both or as a non-limiting example a mass storage device such as a disk or a Solid-State Drive. BIOS Instructions may be stored within the memory 325 to support an operating system.

The inter-station communication manager 365 manages communications with other base stations. The Inter-Station communication manager 365 may provide a standardized Xn interface, as defined by the 3GPP standard, to support these communications.

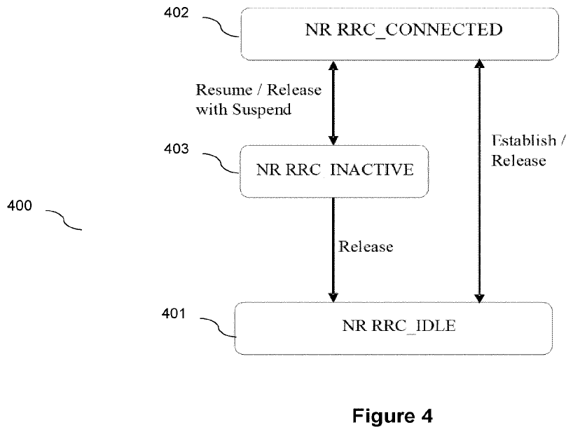

FIG. 4 is a flowchart 400 showing the RRC connection states and transitions for a UE in 5G NR. The RRC protocol operates between a UE and a base station (gNB) and is defined in 3GPP specifications TS 38.331 for 5G NR. The UE's state names are prefixed with “NR” for New Radio. Other prefixes are used for other radio interfaces like LTE radio interface. For the sake of simplicity, the radio technology prefix is omitted in the rest of the description.

Radio Resource Control (RRC) is a layer within the 5G NR protocol stack. It exists only in the control plane, in the UE and in the gNB. The behavior and functions of a base station and a UE are governed by the current RRC state of the UE. In 5G NR, three distinct RRC states are specified for a UE: RRC_IDLE state 401, RRC_CONNECTED state 402 and RRC_INACTIVE state 403.

At power-up the UE is in RRC_IDLE state 401, it performs radio link quality measurements and executes the cell selection evaluation process (as defined in 3GPP specifications TS 38.304) to identify a target gNB to connect to. The UE state changes to RRC_CONNECTED state 402 upon an RRC connection establishment with the target gNB that becomes the source gNB serving the UE. In the following, the source base station (or source gNB) may also be referred to as the serving base station or serving gNB. If there is no radio activity for a while, the RRC connection can be released by the source gNB, then the UE's RRC state changes back to RRC_IDLE state 401.

While releasing an RRC connection is interesting for capacity utilization and power saving, it is not ideal from the latency perspective. The overhead in establishing an RRC connection requires extra signaling that introduces delay. To cope with this drawback, the RRC_INACTIVE state 403 has been introduced for 5G NR. When the UE is in RRC_INACTIVE state 403, the UE cannot communicate with the 5G system, but both the source gNB (e.g. last serving gNB) and the UE store the UE context or configuration. The stored UE context or configuration includes information to facilitate quick resumption of the connection. The information may include the security context (e.g. security parameters such as security key, UE security capabilities), measurement configuration, radio configuration (e.g. UE radio capability), information about bearers, PDU session context etc. Thus, when in RRC_CONNECTED state 402, the RRC connection can be suspended by the source gNB (Release with suspend), and the UE moves to the RRC_INACTIVE state 403. From the RRC_INACTIVE state 403, the UE can be switched back to the RRC_CONNECTED state 402 by the gNB (Resume) and the UE applies the stored UE context or configuration. The RRC resume message is sent by a gNB upon reception of a RRC resume request message from the UE.

From either the RRC_CONNECTED state or RRC_INACTIVE state, the UE can transit to RRC_IDLE state upon a RRC release command received from the gNB.

The mobility procedure to migrate a UE from one cell to another depends on the UE's RRC state. In RRC_CONNECTED state, the mobility procedure, called handover, is controlled by the network, and the source gNB takes the decision to trigger the handover procedure based on the measurement reports provided by the UE. In RRC_INACTIVE and in RRC_IDLE states (e.g. non-connected states), the mobility procedure is called cell reselection, and it is managed by the UE itself.

In RRC_INACTIVE state, the UE can be configured by the network with a RAN Notification Area (RNA). For example, the message that transitions the UE to the RRC_INACTIVE state contains information indicating the RNA. The RNA is the area within which the UE can move without notifying the network. When the UE in the RRC_INACTIVE state moves to a cell that is not part of its currently assigned RNA, the UE performs a location-update procedure that enables the RAN (e.g. serving gNB) to update the RNA assigned to the UE. In other words, the UE has the possibility to request an RNA update to be informed of a modification of the RNA. When, as part of the cell reselection process, the UE selects a cell managed by a target gNB out of the RNA, the UE sends a resume request to the target gNB, which has three options available: to keep the UE in RRC_INACTIVE state, to set the UE in RRC_IDLE state, or to set the UE in RRC_CONNECTED state.

In RRC_IDLE state, the paging procedure to inform a UE that it has to resume the connection is initiated by the core network. In RRC_INACTIVE state, the paging procedure is initiated by the NG RAN (i.e. the last gNB that had set the UE in RRC_INACTIVE state).

Back to the FIG. 1, it is assumed that the UE 101 is in the RRC_INACTIVE state and that it is receiving multicast data of one or more multicast MBS sessions generated by the multicast application server 103. The multicast data are provided to the base station 111, which is the base station controlling the cell 121 on which the UE 101 is camping, through the core network 102 and the transport bearer (also known as GTP-U tunnel) 106 over the link 141. Then, the multicast data are transmitted by the base station 111 to the UE 101 through the MBS Radio Bearer (MRB) 154. FIG. 1 also shows the UE 151 receiving data through MRB 153. In a point-to-multipoint transmission of data from the base station 111, the MRB 154 is the same MRB as MRB 153. In a point-to-point transmission, the MRBs 154 and 153 are different. A radio bearer is a set of PHY (layer 1) and MAC (layer 2) parameters allowing higher layer data connection between a UE and a gNB. Multiple types of radio bearers are defined in 5G NR: the SRB (Signalling Radio Bearer) for the control plane, the DRB (Data Radio Bearer) allowing point-to-point communication with one UE in the user plane (unicast), and the MRB allowing point-to-point communication and point-to-multipoint communication with multiple UEs (multicast/broadcast), also in the user plane.

The MBS session join procedure, as specified in 3GPP TS 23.247, is used by UEs to inform the 5GC of an interest in joining a multicast MBS session. The first accepted UE join request triggers the multicast MBS session establishment towards the NG RAN and the UE. Before sending a join request for a multicast MBS session, the UE should have established a PDU session that can be associated with multicast session(s), using the procedures as specified in TS 23.502. Also, the UE should know at least the MBS Session id of a multicast group that the UE can join, via service announcement broadcasted by the network. To join the multicast group, the UE sends a PDU Session Modification Request for the associated PDU session which contains one or several MBS Session id(s) and a join request. The MBS Session id(s) indicates the multicast MBS session(s) that UE wants to join.

To join an MBS session, the UE has to be in the RRC_CONNECTED state.

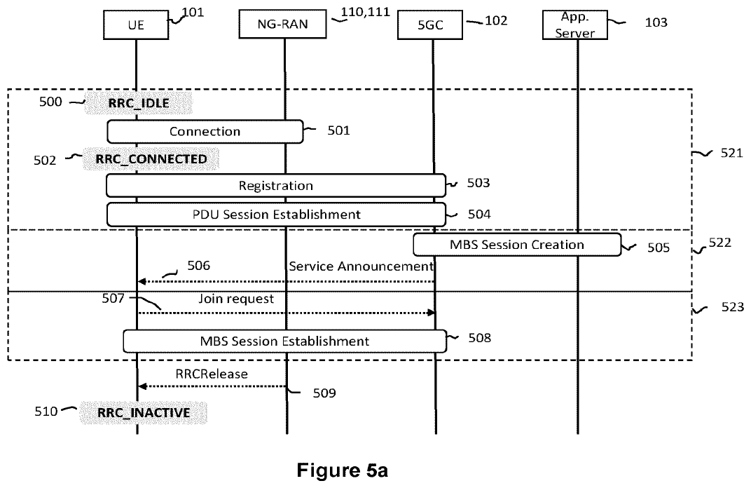

FIGS. 5a and 5b together illustrates example message flows for an example scenario of MBS session evolution from creation to activation. FIG. 5a illustrates an example message flow for MBS session creation and establishment and FIG. 5b illustrates an example message flow for MBS session activation.

Referring first to FIG. 5a, UE, for example UE 101 (or it could be UE 151), is powered up and enters the RRC_IDLE state 500. During step 501, the UE connects to the closest gNB (for example, in the case of FIG. 1, UE 101 connects to gNB 111) as a result of the cell selection process defined in TS 38.304 clause 5.2.3. Once connected to the gNB, the UE enters the RRC_CONNECTED state 502. Then the UE executes the registration process or procedure 503 aiming at identifying the UE in the core network or 5GC 102, checking the UE subscriptions and enforcing the authorisations. The registration procedure is detailed in TS 23.502 clause 4.2.2.2.

After registration, the UE creates a first PDU session via a PDU session establishment procedure 504. The first PDU session is a default PDU session allowing access to 5G core services. This PDU session can be later associated to the MBS session. PDU session establishment procedure is defined in TS 23.502 clause 4.3.2.

The AF (Application function) 104, in the 5G core 102, creates a multicast session on demand of the application server 103. The MBS session creation procedure 505 for creating the multicast session is defined in TS 23.247 clause 7.1.1. The session creation is driven by the AF 104 (Application Function), and on completion, the result is a MBS session id (for example, TMGI for Temporary Mobile Group Identity) allocation for the multicast session and session creation.

Once the multicast session is created, the AF 104 performs a service announcement 506 towards the UEs, e.g. the AF 104 sends a service announcement message. The service announcement message includes multicast session information which includes, among other things, the multicast MBS session id, service area description (or information) and session description information. Service announcement is described in TS 23.247 clause 6.11. Some UEs may not need to receive the service announcement message: for example service information provided in the service announcement can be pre-configured at some UEs. Also, UEs that are not connected at the time of the service announcement can access the service information by soliciting directly the AF 104 (Application Function) or MBSF (MBS Service Function) in the core network 102.

There is no timing dependencies between UE connection/registration/PDU session establishment procedures (collectively identified by reference number 521) and MBS session creation/announcement procedures (collectively identified by reference number 522). Both 521 and 522 are performed independently from each other and can happen at any time.

Once the UE 101 is registered in the core network 102 and a default PDU session is established and multicast service information is known, then UE may send or perform a join request 507 to the core network 102 to enrol in the multicast session. The multicast session information (such as, multicast MBS session id, etc. as described above) is known by the UE either after receiving the service announcement message 506, or by pre-configuration, or by soliciting the information from the core network (message flow for pre-configuration of or soliciting session information is not shown in FIG. 5a or 5b). To join a multicast session the UE may reuse the default PDU session created earlier (at 504), and send a PDU session modification request including the multicast session id (TMGI). The PDU session modification request is then considered as a join request (507). Another possibility is to establish a dedicated MBS PDU session including the multicast session id for join request 507.

When the core network 102 receives a join request 507, it performs the multicast session establishment procedure 508. During the session establishment procedure 508, the core network 102 verifies the UE's subscriptions and authorization levels to check if the UE is allowed to access the multicast session (i.e. to check the UE is one of a particular multicast group of UEs authorised to receive the multicast session). Also, as part of the session establishment procedure 508 the core network 102 will setup necessary resources in the core network to covey the multicast data from the application server 103 to the concerned gNBs. The concerned gNBs are defined by the multicast service area information established at session creation step 505. The join procedure 507 and the multicast session establishment procedure 508 are defined in TS 23.247 clause 7.2.1.

In the example shown in FIG. 5a, the gNB of the NG-RAN (e.g. gNB 111) decides to switch the UE 101 to RRC_INACTIVE state 510 by sending a RRCRelease message 509 (TS 38.331 clause 6.2.2). The most common reason is load management, the gNB may decide to offload its control plane load by switching some UEs to RRC_INACTIVE. Also, on-going discussions for Release 18 suggest that both UEs and core network provide additional information to the gNB to help the gNB take the decision to switch some UEs to RRC_INACTIVE state. The additional information may include capacity information from both UE and Core network indicating the ability to send or receive multicast data in RRC_INACTIVE state. Other information may also be provided by the UEs to express a preferred state for receiving the multicast data: i.e. RRC_INACTIVE or RRC_CONNECTED.

Referring now also to FIG. 5b, with the UE in RRC_INACTIVE state 510, UEs shall perform as a background task the cell reselection process 511. This process manages the UE mobility allowing “reselecting” a new gNB depending on the new UE location. Cell reselection is described in detail in TS 38.304 clause 5.2.4. In this example it is assumed that the NG-RAN node is either gNB 110 or gNB 111 depending on UE movement.

Once the MBS session is created (505), the AF 104 (Application Function) in the core network 102 can be triggered to activate the multicast session (i.e. MBS session activation 512). The trigger to activate the multicast session is independent from the join and session establishment procedures (collectively identified by reference number 523). One possible trigger is the availability of data from the application server 103. Multicast session activation is described in TS 23.247 clause 7.2.5.2. The main result of this procedure is the RAN (Radio Access Network) resource reservation by the gNBs. These resources allow the communication of the multicast data to the UEs that has already joined the multicast session. The RAN resources allocation includes the MRB configuration (MBS Radio Bearer configuration). Each gNB will use a particular configuration for the MRB for the multicast session.

Once the multicast session is activated on completion of the MBS session activation 512, the core network 102 may need to page some UEs to notify them of the availability of the multicast data. RRC_INACTIVE UEs need to be paged because as explained in 510, RRC_INACTIVE UEs are still moving and may enter into the cell of another gNB, but neither the new gNB (target gNB) nor the first gNB (source gNB) are aware of the UE movement at this step (i.e. at the time the multicast session is activated 512). The core network 102 sends a group page request to the gNBs with the MBS session id (not shown in FIG. 5b), then each gNB sends a group paging 513 request with the multicast session id. This sequence is described as step 5 in TS 23.247 clause 7.2.5.2.

Upon reception of the group page message 513, RRC_INACTIVE UEs shall prepare to resume the RRC connection during the processing 515.

As part of the RRC connection resume preparation, the UE 101 performs a Random Access procedure toward the gNB (PRACH procedure 516, PRACH stands for Physical Random Access Channel). The PRACH procedure aims at updating the UE's system information in case it has moved to another cell or in case the system information has not been updated for a while. Then the UE 101 performs and completes the connection resume procedure in 517, which includes sending a RRCResumeRequest message (not shown in FIG. 5b). The connection resume procedure 517 follows the RRC connection procedure which is defined in detail in TS 38.331.

Once the RRC connection procedure is done, the UE is in RRC_CONNECTED state 518.

It is only at that step when the UE 101 is in RRC_CONNECTED state 518 that the gNB 111 may send the multicast configuration (including the MRB information) to the UE, step 519, which includes sending a RRCReconfiguration message (TS 38.331 clause 6.2.2) including the MRB information.

Once the UE applies the received multicast configuration, it can receive the multicast data in 520.

As discussed in the introduction, with the UE having to switch from the RRC_INACTIVE state into the RRC_CONNECTED state to perform the configuration for multicast reception, the additional signalling and other resources required to configure the UE in the RRC_CONNECTED state adds to the load issues at the NG-RAN node, gNB, (i.e. too many UEs in the RRC_CONNECTED state), and so the benefits of having UEs switched to the RRC_INACTIVE state to avoid congestion are lost or at least reduced. For example, the paging, PRACH, MBS configuration processes to resume to the RRC_CONNECTED state, as discussed above, can cause link congestion and delay issues.

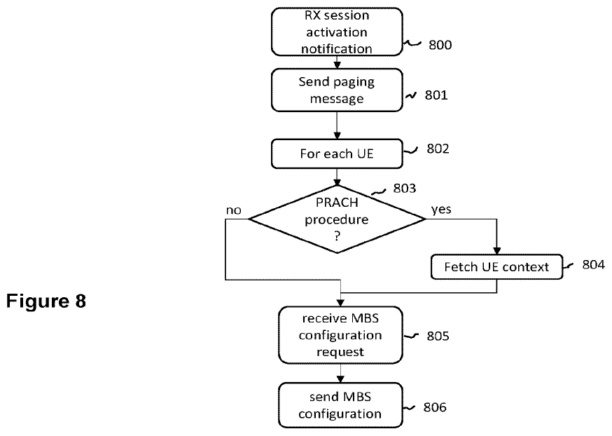

Referring now to FIG. 9 which shows steps of a method 900 for configuring a UE of a wireless communication system to setup multicast reception in accordance with an embodiment of the present invention, which method is performed by the UE. The wireless communication system may be, for example, the wireless communication system 100 of FIG. 1 and the UE may be UE 101 and may comprise the UE 205 of FIG. 2 with the method 900 being performed by the processor 215.

The UE 101 is operating in a non-connected Radio Resource Control (RRC) state (such as a RRC_INACTIVE state) and has previously joined one or more multicast sessions. For example, the UE 101 has performed a joining session procedure by sending to the core network 102 a join request 507 (such as a PDU session modification request including the multicast session id or by establishing a dedicated MBS PDU session) as discussed above.

The multicast session for which the UE is to be configured is currently not activated and so the UE is in the non-connected state or RRC_INACTIVE state. As discussed above with reference to FIG. 4, in the non-connected RRC state (e.g. RRC_INACTIVE state), the UE 101 cannot communicate with the core network 102 but the UE context or configuration is stored at the UE and the RAN (e.g. at the last serving gNB, which may be controlling the cell where the UE is currently camped if the UE has not moved or has not moved out of the cell controlled by the last serving gNB) which information helps to speed up the UE's transition to the connected state. In the example shown in FIG. 1, the UE 101 is camped in cell 121 which is controlled by the base station 111 or gNB 111.

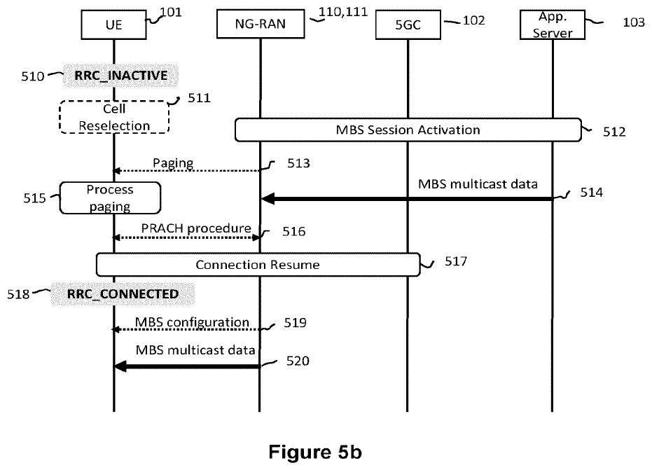

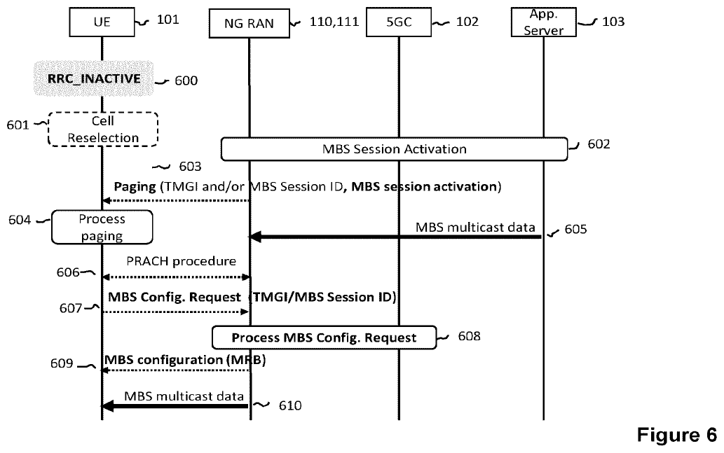

Briefly, at step 901, the UE (e.g. UE 101) receives a notification indicating the multicast session, for which the UE has previously joined, has been activated. In an example and as discussed below in more detail with reference to FIGS. 6 and 7, the core network 102 activates the multicast session (e.g. when there is multicast data to be sent) and a notification is sent in response to the MBS session activation to UEs from the core network 102 via base stations (e.g. gNBs serving the cells covering the MBS service area for the multicast session). The notification (e.g. group page message 603 of FIGS. 6 and 7) may include an identifier for identifying the activated multicast session (e.g. MBS session id and/or TMGI) and may include information indicating the multicast session has been activated (e.g. MBS session activation cause information-which indicates the reason for the notification is the activation of the multicast MBS session). The notification may be a paging message, such as a group page which may include a field that can be set to “mbs session activation” when the multicast session is activated. As mentioned above, the paging message is sent by all gNBs covering the multicast service area and so the UE 101 may receive a paging message, at step 901, from at least one of the gNBs covering the multicast service area, such as gNB 111. With the UE in the RRC-INACTIVE state, when the multicast session is activated, the network does not know where the UE is located (e.g. the UE may have changed cells) and so sending the notification (e.g. paging message) helps to notify the UE (and other UEs that have previously joined the multicast session in each cell of the MBS service area) of the multicast session activation . . .

After receiving the notification of multicast session activation, the UE may determine based on information included in the notification (e.g. based on an identifier for identifying the activated multicast session and/or the presence of the information indicating the multicast session has been activated, if included in the notification) whether the notification indicates that a multicast session to which the UE has previously joined has been activated. If the identifier for identifying the activated multicast session included in the notification matches an identifier for the multicast session that the UE has previously joined (which is stored in the UE on completing of the join procedure) and/or the information indicating the multicast session has been activated, then the UE determines that the notification does indicate the multicast session that the UE has previously joined has been activated.

In an example, after receiving the notification of multicast session activation and for example, in response to determining that the notification indicates a multicast session that the UE has previously joined has been activated, the UE 101 may perform a random access procedure toward the base station (e.g. referred to as a source or serving base station) which is controlling the cell where the UE 101 is currently camping. In the example shown in FIG. 1, the source base station for the UE 101 camped in cell 121 is gNB 111. The random access procedure may be a PRACH (Physical Random Access Channel) procedure as defined in TS 38.311 clause 5.2.2.3.3, to update the UE's system information when needed. For example, updating the system information of the UE (e.g. context information for the UE) may be needed when the system information is out-of-date which may occur when certain conditions are met, such as in the case the UE has moved to another cell or in the case the system information has not been updated for a while.

After receiving the notification of multicast session activation and for example, in response to determining that the notification indicates a multicast session that the UE has previously joined has been activated, the UE then, at step 902, sends or transmits a MBS configuration request message for requesting configuration information for the reception of multicast data in a non-connected RRC state, such as RRC_INACTIVE state, for the activated multicast session. The MBS configuration request message is sent, in response to receiving the notification, to the base station (e.g. source or serving base station) controlling the cell where the UE is camped. For example for the arrangement of FIG. 1, the UE 101 sends to the source gNB 111 a MBS configuration request message for requesting configuration information for the reception of multicast data in a non-connected RRC state, such as RRC_INACTIVE state, for the activated multicast session. The MBS configuration request message may be a new RRC message or a RRCResumeRequest message or a System Information Block (SIB) reception request as discussed in more detail below.

The MBS configuration request message (e.g. MBS configuration request message 607 of FIGS. 6 and 7) may include an identifier for identifying the activated multicast session (e.g. MBS session id and/or Temporary Mobile Group Identity (TMGI)). In other words, an identifier for indicating the MBS session the configuration is requested for. In addition, the MBS configuration request message may include UE identity information for identifying the UE 101, such as IMSI, IMEI, and/or Authentication information (ueMAC-I), such as an authentication token, for use in authenticating the UE 101.

At step 903, the UE 101 receives a MBS configuration message which includes configuration information for configuring the UE for reception of multicast data in a non-connected RRC state, such as RRC_INACTIVE state, for the activated multicast session. The MBS configuration message is sent, in response to receiving the MBS configuration request message, by the base station (e.g. source or serving base station) controlling the cell where the UE is camped. For example in the arrangement of FIG. 1, the UE 101 receives from the gNB 111 a MBS configuration message for configuring the UE for reception of multicast data in a non-connected RRC state, such as RRC_INACTIVE state, for the activated multicast session. The MBS configuration message (e.g. MBS configuration message 609 of FIGS. 6 and 7) may be a RRCReconfiguration message or a RRCRelease with suspend configuration message or a RRCResume message or a SIB message as discussed in more detail below.

In an example, the configuration information includes configuration information of at least one Multicast Radio Bearer, MRB (e.g. configuration of at least one MRB to be used by the gNB 111 for the activated multicast session). It is noted that one or more MRBs can be associated to one MBS session. The MRB configuration information may include Packet Data Convergence Protocol (PDCP) and Service Data Adaptation Protocol (SDAP) setup information.

In response to receiving the MBS configuration message, the UE 101 configures the UE 101 for reception of multicast data in a non-connected RRC state (e.g. RRC_INACTIVE state) based on the configuration information in the received MBS configuration message. In other words, the UE 101 performs radio bearer configuration and configures itself (e.g. sets up the user plane in the UE 101 according to the radio configuration of the base station) to receive multicast data of the activated multicast session from the base station (e.g. source gNB 111).

Once the UE 101 is configured, the UE 101 may receive data, from the gNB 111, for the multicast session.

Steps 901, 902 and 903 are performed whilst the UE 101 is operating in the non-connected RRC state (e.g. RRC_INACTIVE state). In addition, the configuring of the UE 101 and receipt of multicast data by the UE are also performed whilst the UE 101 is operating in the non-connected RRC state (e.g. RRC_INACTIVE state). Thus, the UE 101 is kept in RRC_INACTIVE state during the whole process and is able to acquire the necessary configuration for multicast data reception from the network (e.g. gNB 111 or core network 102) as soon as it is available.

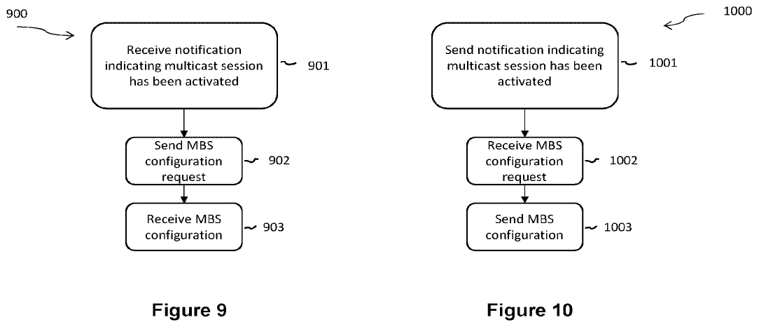

Referring now also to FIG. 10 which shows steps of a method 1000 for use in configuring a UE of a wireless communication system to setup multicast reception in accordance with an embodiment of the present invention. Method 1000 is performed at a base station (e.g. source or serving base station) controlling a cell on which one or more UEs are camping. The wireless communication system may be, for example, the wireless communication system 100 of FIG. 1. With respect to the example shown in FIG. 1, the base station performing method 1000 may be base station 111 or gNB 111 which controls the cell 121 and the one or more UEs include UEs 101 and 151 currently camped on the cell 121 (current serving cell). The base station may comprise the base station 305 of FIG. 3 with the method 1000 being performed by the processor 315. The UE 101 is operating in a non-connected Radio Resource Control (RRC) state (such as a RRC_INACTIVE state) and has previously joined one or more multicast sessions as discussed above with reference to FIG. 9.

Briefly, at step 1001, the base station (e.g. gNB 111) sends a notification indicating a multicast session has been activated. In an example and as discussed below in more detail with reference to FIGS. 6 and 7, the core network 102, as part of a MBS session activation procedure (e.g. the MBS session activation procedure shown as 512 in FIGS. 5a and 602 in FIG. 6 which is further detailed in TS 23.247 clause 7.2.5), activates the multicast session (e.g. when there is multicast data to be sent) and sends a MBS session activation message (e.g. group page request) to the base stations (e.g. gNBs) serving the cells covering the MBS service area for the multicast session (e.g. as identified by the MBS session id), which message informs the base stations of the MBS session activation and requests that the base stations notify RRC_INACTIVE UEs that have previously joined the multicast session of the MBS session activation. In response to the message from the core network 102, the base station 111 (along with the other base stations covering the MBS service area) sends the notification indicating the multicast session, for which the UE has previously joined, has been activated. The notification sent by the base station may include an identifier for identifying the activated multicast session (e.g. MBS session id and/or TMGI) and may include information indicating the multicast session has been activated (e.g. MBS session activation cause information-which indicates the reason for the notification is the activation of the multicast MBS session). The notification may be a paging message, such as a group page, which may include a field that can be set to “mbs session activation” when the multicast session is activated. Thus, in the example of FIG. 1, base station or gNB 111 sends a paging message, at step 1001, which should be received by at least the UEs located in the cell 121 served by the gNB 111.

In an example, a base station or gNB may determine whether the UEs are capable of receiving multicast in RRC_INACTIVE state and if the AF 104 (Application Function) allows the reception of multicast data by UEs in RRC_INACTIVE state. If the gNB determines the UEs are capable of receiving multicast in RRC_INACTIVE state and the AF 104 (Application Function) allows the reception of multicast data by UEs in RRC_INACTIVE state, then the gNB may send a group paging message including an identifier for identifying the activated multicast session (e.g. MBS session id and/or TMGI) and information indicating the multicast session has been activated (e.g. MBS session activation cause information-which indicates the reason for the notification is the activation of the multicast MBS session)—i.e. an enhanced group paging message. Otherwise, if the gNB determines the UEs are not capable of receiving multicast in RRC_INACTIVE state or the AF 104 (Application Function) does not allow the reception of multicast data by UEs in RRC_INACTIVE state, the gNB sends the standard group paging message 513 as defined in FIG. 5b. Both UE and AF capabilities are known at the gNB since the session establishment 523. The gNB might also take into account the UE preference to receive in connected or in non-connected mode (also known at session establishment).

On receipt of the notification, each UE can determine, based on the identifier for the activated multicast session, and the presence of the information indicating the multicast session has been activated whether the notification indicates that a multicast session to which the UE has previously joined has been activated.

The base station 111, at step 1002, receives a MBS configuration request message for requesting configuration information for the reception of multicast data in a non-connected RRC state, such as RRC_INACTIVE state, for the activated multicast session. The MBS configuration request message is received from at least one of the one or more UEs which is operating in a non-connected RRC state (such as a RRC_INACTIVE state) and which has previously joined the multicast session: for example, the at least one UE may be UE 101 camped in the cell 121 and which is operating in a RRC_INACTIVE state and has previously joined the multicast session that has been activated. The at least one UE 101 sends the MBS configuration request message in response to receiving the notification from the base station and determining that the notification indicates that a multicast session to which the at least one UE has previously joined has been activated. The MBS configuration request message may be a new RRC message or a RRCResumeRequest message or a System Information Block (SIB) reception request as discussed above with reference to FIG. 9 and as discussed in more detail below.

The MBS configuration request message may include an identifier for identifying the activated multicast session (e.g. MBS session id and/or TMGI). In other words, an identifier for indicating the MBS session the configuration is requested for. In addition, the MBS configuration request message may include UE identity information for identifying the at least one UE 101, such as IMSI, IMEI, and/or Authentication information (ueMAC-I), such as an authentication token, for use in authenticating the at least one UE 101.

In an example, upon reception of the MBS configuration request message, the base station or gNB 111 processes the MBS configuration request message which may include gathering or obtaining the necessary information to build the UE configuration for the at least one UE so the at least one UE can receive multicast data for the activated multicast session. Once the UE configuration is known (including the step of Radio Access Network (RAN) resource reservation), the base station or gNB 111 sends an MBS configuration message to the at least one UE, at step 1003. The MBS configuration message includes configuration information for configuring the at least one UE for reception of multicast data in a non-connected RRC state, such as RRC_INACTIVE state, for the activated multicast session. In an example, the configuration information includes configuration information of at least one Multicast Radio Bearer, MRB (e.g. configuration of at least one MRB to be used by the gNB 111 and the at least one UE 101 for communication of the multicast data for the activated multicast session). It is noted that one or more MRBs can be associated to one MBS session. The MRB configuration information may include Packet Data Convergence Protocol (PDCP) and Service Data Adaptation Protocol (SDAP) setup information.

The MBS configuration message is sent to the at least one UE by the base station (e.g. source or serving base station) controlling the cell where the UE is camped and is sent in response to receiving the MBS configuration request message from the at least one UE. For example in the arrangement of FIG. 1 where the UE 101 has sent the MBS configuration request message, the gNB 111 sends to the UE 101 a MBS configuration message for configuring the UE 101 for reception of multicast data in a non-connected RRC state, such as RRC_INACTIVE state, for the activated multicast session. The MBS configuration message may be a RRCReconfiguration message or a RRCRelease with suspend configuration message or a RRCResume message or a SIB message as above with reference to FIG. 9 and as discussed in more detail below.

In the case when more than one UEs are in a non-connected RRC state and have previously joined the same multicast session and are camped on the same cell controlled by a base station, in response to the notification sent by the base station and which notification includes the multicast session identifier for the multicast session, each of the UEs that have previously joined the multicast session (and so have knowledge of the multicast session identifier) send a MBS configuration request message to the base station controlling the cell. The base station then sends a MBS configuration message to each of the UEs in response to the respective MBS configuration request message received at the base station.

By sending a notification indicating the multicast session has been activated on MBS session activation, the UE can determine that the notification concerns MBS session activation and this helps to prevent UEs from automatically initiating a RRC resume procedure and switching to the RRC_CONNECTED state. Furthermore, by configuring the UE in the RRC_INACTIVE state after notification that the multicast session has been activated, requiring the UE to switch to the RRC_CONNECTED state at the activation of the multicast MBS session can be avoided which means the number of UEs in the RRC_CONNECTED state can be reduced with a resulting reduction in congestion at the gNB. Furthermore, in an example, where the notification sent by the base station is a group paging message, using a group paging message is simpler than having to page individually all UEs, but a corrupted UE may pretend to have joined the session earlier to tamper with the multicast session. By having the MBS configuration request/response protocol run by the UE to request the MBS configuration, the gNB is able to perform an access authorization check and may deny the configuration to a corrupted UE (e.g. by not responding to the MBS configuration request message sent by the corrupted UE).

Referring now also to FIG. 6 which shows an example message flow in accordance with an example embodiment of the invention. The message flow is described with reference to the wireless communication system of FIG. 1 where the UE is UE 101, the NG RAN is gNB 110 (when the UE 101 in cell 121) or gNB 111 (when the UE 101 is in cell 120), 5GC is the core network 102 and app. server is the MBS application service 103.

In this example, procedures like the UE registration 521, the MBS session creation 522, the UE join 523 and the UE switch to RRC_INACTIVE 509, as described above with reference to FIG. 5a, have already happened.

The UE 101, in RRC_INACTIVE state 600, performs as a background task the cell reselection process 601. This process manages the UE mobility allowing “reselecting” a new gNB depending on the new UE location. Cell reselection is described in detail in TS 38.304 clause 5.2.4. In this example it is assumed that the NG-RAN node serving the cell on which the UE 101 is camping is either gNB 110 or gNB 111 depending on UE movement.

The AF 104 (Application Function) in the core network 102 can be triggered to activate the multicast session (MBS session activation 602). Multicast session activation is described in TS 23.247 clause 7.2.5.2. The main result of this procedure is the RAN (Radio Access Network) resource reservation by the gNBs. These resources allow the communication of the multicast data to the UEs that have already joined the multicast session. The RAN resources allocation includes the MRB configuration (MBS Radio Bearer) over which the multicast data is communicated.

Once the multicast session is activated, the core network 102 may need to page some UEs to notify them of the availability of the multicast data. RRC_INACTIVE UEs need to be paged because as explained in 601, RRC_INACTIVE UEs are still moving and may enter into the cell of another gNB, but neither the new gNB (target gNB) nor the first or last serving gNB (source gNB) are aware of the UE movement at this step and so do not know in which cell the UE is currently located. The core network 102 sends a group page request to the gNBs with the MBS session id (not shown in the figure), then each gNB sends a group paging (as discussed above with reference to FIGS. 9 and 10, group paging is an example of a notification sent by the gNBs to the UEs) to RRC_INACTIVE UEs. However, unlike the processing of the paging message (e.g. process paging 515 of group page message 513) as described above with reference to FIG. 5b, in accordance with embodiments of the invention, the UE shall not request to resume the RRC connection (so as to remain in the non-connected RRC state) in response to the paging message and so the group paging sent by the gNBs is enhanced so that UEs can adopt a different behaviour when processing the paging message than the one described above for process paging in 515. To reach the RRC_INACTIVE UEs, each gNB may send a group paging/page message or notification 603 including, in addition to the multicast session id for identifying the activated multicast session, the multicast session activation paging cause indicating a multicast session has been activated. The Multicast session id is for example the TMGI (Temporary Mobile Group Identity) as obtained as a result of MBS session creation 522. It is noted that, in an example, destination UEs are not explicitly listed by ue_identity (i.e. UE identity allocated by upper layers) in the notification 603 which is why it may be considered as a group paging message.

In an example, a base station or gNB may determine whether the UEs are capable of receiving multicast in RRC_INACTIVE state and if the AF 104 (Application Function) allows the reception of multicast data by UEs in RRC_INACTIVE state. If the gNB determines the UEs are capable of receiving multicast in RRC_INACTIVE state and the AF 104 (Application Function) allows the reception of multicast data by UEs in RRC_INACTIVE state, then the gNB may send a group paging message including an identifier for identifying the activated multicast session (e.g. MBS session id and/or TMGI) and information indicating the multicast session has been activated (e.g. MBS session activation cause information-which indicates the reason for the notification is the activation of the multicast MBS session)—i.e. an enhanced group paging message. Otherwise, if the gNB determines the UEs are not capable of receiving multicast in RRC_INACTIVE state or the AF 104 (Application Function) does not allow the reception of multicast data by UEs in RRC_INACTIVE state, the gNB sends the standard group paging message 513 as defined in FIG. 5b. Both UE and AF capabilities are known at the gNB since the session establishment 523. The gNB might also take into account the UE preference to receive in connected or in non-connected mode (also known at session establishment).

Based on 3GPP TS 38.331 version 17.0.0, section 5.3.2.3, the reception of the Paging message by the UE may proceed as follows:
1> for each TMGI included in pagingGroupList, if any, included in the Paging message:
   2> if the UE has joined an MBS session indicated by the TMGI included in the pagingGroupList:
      3> forward the TMGI to the upper layers;
1> if in RRC_INACTIVE and the UE has joined one or more MBS session(s) indicated by the TMGI included in the pagingGroupList; and
1> if none of the ue-Identity included in any of the PagingRecord, if included in the Paging message, matches the UE identity allocated by upper layers:
2> If MBS session activation is included in the paging cause
3> Initiate the RRC_INACTIVE multicast reception procedure according to 5.3.X (e.g. as discussed with reference to FIGS. 6-10 and/or discussed below in the discussion of an example procedure for configuring a UE for multicast reception with reference to sections and clauses of TS 38.331 version 17.0.0)
   2> Else, initiate the RRC connection resumption procedure according to 5.3.13 with resumeCause set as below:
      3> if the UE is configured by upper layers with Access Identity 1:
         4> resumeCause is set to mps-PriorityAccess;
      3> else if the UE is configured by upper layers with Access Identity 2:
         4> resumeCause is set to mcs-PriorityAccess;
      3> else if the UE is configured by upper layers with one or more Access Identities equal to 11-15:
         4> resumeCause is set to highPriorityAccess;
      3> else:
         4> resumeCause is set to mt-Access.

The paging message may be as follows:

-- ASN1START
-- TAG-PAGING-START

| | |
|---|---|
| Paging ::= | SEQUENCE { |
| pagingRecordList | PagingRecordList |

OPTIONAL, -- Need N

| | |
|---|---|
| lateNonCriticalExtension | OCTET STRING |

OPTIONAL,

| | |
|---|---|
| nonCriticalExtension | Paging-v1700-IEs |

OPTIONAL
}

| | |
|---|---|
| Paging-v1700-IEs ::= | SEQUENCE { |
| pagingRecordList-v1700 | PagingRecordList-v1700 |

OPTIONAL, -- Need N

| | |
|---|---|
| pagingGroupList-r17 | PagingGroupList-r17 |

OPTIONAL,

| | |
|---|---|
| nonCriticalExtension | SEQUENCE { } |

OPTIONAL
}

| | |
|---|---|
| PagingRecordList ::= | SEQUENCE (SIZE(1..maxNrofPageRec)) OF PagingRecord |
| PagingRecordList-v1700 ::= | SEQUENCE (SIZE(1..maxNrofPageRec)) OF PagingRecord-v1700 |
| PagingGroupList-r17 ::= | SEQUENCE (SIZE(1..maxNrofPageGroup-r17)) OF TMGI-r17 |
| PagingRecord ::= | SEQUENCE { |
| ue-Identity | PagingUE-Identity, |
| accessType | ENUMERATED {non3GPP} OPTIONAL, -- Need N |

...
}

| | |
|---|---|
| PagingRecord-v1700 ::= | SEQUENCE { |
| pagingCause-r17 | ENUMERATED {voice, mbs session activation} |

OPTIONAL -- Need N
}

| | |
|---|---|
| PagingUE-Identity ::= | CHOICE { |
| ng-5G-S-TMSI | NG-5G-S-TMSI, |
| fullI-RNTI | I-RNTI-Value, |

...
}
-- TAG-PAGING-STOP
-- ASN1STOP

PagingRecord field descriptions

accessType
Indicates whether the Paging message is originated due to the PDU sessions from the non-
3GPP access.
pagingRecordList
If the network includes pagingRecordList-v1700, it includes the same number of entries,
and listed in the same order, as in pagingRecordList (i.e. without suffix).
pagingCause
voice Indicates whether the Paging message is originated due to IMS voice. If this field is
present and upper layers indicate the support of paging cause, it implies that the
corresponding paging entry is for IMS voice. If this field is not present but
pagingRecordList-v1700 is present, it implies that the corresponding paging entry is for a
service other than IMS voice. Otherwise, pagingCause is undetermined.
Mbs_session_activation indicates that a multicast session is activated.

Upon reception of the new group page message 603, UEs detects both the multicast session id (TMGI) and the Multicast session activation paging cause in the group page message 603, and then execute the processing 604. For each UE (such as UE 101) that has joined the multicast session identified by the multicast session id, the processing 604 includes preparing to start receiving multicast data and stay in RRC_INACTIVE state.

Then optionally, the UE 101 performs a Random Access procedure toward the gNB (such as the PRACH procedure 517, PRACH stands for Physical Random Access CHannel). This procedure allows the UE 101 to update its system information if needed.

Then the UE 101 sends a MBS configuration request message 607 to ask the gNB 111 to send the configuration information to allow the UE 101 to receive the multicast data corresponding to the activated session as signalled in the page message 603.

Each time it receives a MBS configuration request message from a UE, the gNB prepares a MBS configuration message 609 and sends the MBS configuration message 609 to the UE 101 in response. In this message the UEs will find the MBS radio bearer configuration parameter to apply in order to receive the multicast data corresponding to the activated MBS session. The MBS radio bearer information element includes PDCP (Packet Data Convergence Protocol) and SDAP (Service DATA Adaptation Protocol) setup information as determined at radio resource reservation. Once the MBS radio bearer configuration is done at the UE 101, multicast data can be received 610 while staying in RRC_INACTIVE mode.

FIG. 7 is a flow chart illustrating an example method executed by a UE according to an example of an embodiment of the invention. This method may be executed by the UE 205 (e.g. by the CPU 215 executing instructions stored in memory 225) of FIG. 2, and corresponds to handling the message flows 603 to 610 of FIG. 6.

At first, during step 700, the communication manager 220 receives an incoming frame from the transceiver 235 and decodes it as a page message (e.g. paging message 603) from a base station (110, 111), the page message is received on the PCCH (Paging Control Channel). The page message format is defined in TS 38.331 clause 6.2.2 except for the paging cause field which is amended in this example of an embodiment of the invention to add a new cause called “mbs session activation”.

During step 701, the UE 205 checks if the TMGI (Temporary Mobile Group Identity) of multicast session it has joined in 523 is present in the PagingGroupList-r17 field of the received page message. The TMGI is used as the multicast session id to identify the activated multicast session and is stored in the memory 225. If the UE's stored TMGI is not found in the page message 603 (no branch at step 701) then the processing is ended (step 709).

If the UE's stored TMGI is found in the page message (yes branch at step 701), then during step 702 the ue_identity field of each PagingRecord field of the received page message is compared to the UE's own identity. If the ue_identity field matches the UE's own identity as defined by upper layers (no branch at step 702) then the processing is ended (step 709).

Otherwise when the ue_identity field does not match the UE's own identity as defined by upper layers (yes branch at step 702), during step 703, the paging cause field of the paging record is read. If the paging cause is not set to “mbs session activation” (no branch at step 703), then during step 704, the RRC connection is resumed according to clause 5.3.13 of TS 38.331.

In another example where the TMGI and paging cause is included in the page message, step 702 may be omitted since the UE can determine from the TMGI and paging cause whether the page message relates to a MBS session that the UE has joined and which has been activated without needing to check the matching of the ue_identity field. Step 702 may be performed to ensure backward compatibility with prior releases where UEs with matching UE identity are required to switch to RRC_CONNECTED.

If the paging cause is set to “mbs session activation” (yes branch at step 703), then during step 705, the relevance of the system information stored in the UE's memory 225 is evaluated. If the gNB selected during the cell reselection process 511/601 is different from the gNB that performed the RRC connection release 509, then the UE's system information is obsolete. Also, if the gNB has not changed between 509 and 511/601, but if a long time has elapsed since RRC connection release 509, then the UE's system information is also considered as obsolete.

If the system information is determined to be obsolete and so needs updating (yes branch at step 705), during step 706 the UE 205 will renew the system information by executing a PRACH (Physical Random Access Channel) procedure as defined in TS 38.311 clause 5.2.2.3.3.

Step 707 is executed when system information is renewed (706) or evaluated as relevant (no branch at step 705). During this step 707, the UE 205 sends a MBS configuration request message 607 to ask the gNB (for example, gNB 111) to send the configuration information to allow receiving the multicast data corresponding to the activated session as signalled in the received page message 603.

In one example, the MBS configuration request message 607 is implemented as a new RRC message sent on the signalling radio bearer 0 on the CCCH (Common Control Channel). The message includes at least the identifier of the activated multicast session (e.g. TMGI) as received in the page message 603 and may also include the UE identity as stored in the system information. For example the UE identity can be the Short I-RNTI (Inactive-Radio Network Temporary Identifier) value or the Full I-RNTI value.

Alternatively, the MBS configuration request message 607 is implemented as a modified RRCResume request message as defined in TS 38.331 clause 6.2.2 with an additional field containing the TMGI.

Then during step 708, the UE 101 receives the MBS configuration message 609, from the gNB. In this MBS configuration message 609 the UE 205 will find the MBS radio bearer configuration parameter to apply in order to the received the multicast data corresponding to the MBS session activation as notified in the paging message 603. The details of the MBS radio bearer information element can be found in TS 38.331 clause 6.3.2. It includes PDCP (Packet Data Convergence Protocol) and SDAP (Service DATA Adaptation Protocol) setup information and allows the UE to receive the multicast data while staying in RRC_INACTIVE state.

In one example, the MBS configuration message 609 is implemented as a new RRC message sent by the gNB on the signalling radio bearer 1 (SRB1) on the CCCH (Common Control Channel). The message includes at least a RRC transaction identifier, and a MBS configuration information element as defined in TS 38.331 clause 6.3.2.

Once the MBS radio bearer configuration is done, multicast data can be received while staying in RRC_INACTIVE mode and the processing is ended (step 709).

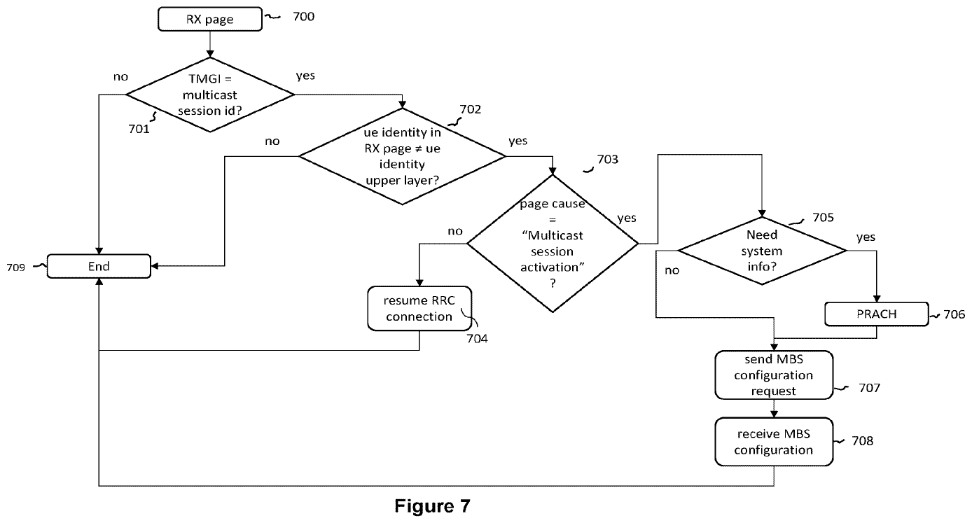

FIG. 8 is a flow chart illustrating an example method executed by a base station (e.g. gNB) according to an example of an embodiment of the invention. This method may be executed by the base station 305 (e.g. by the CPU 315 executing instructions stored in memory 325) of FIG. 3, and corresponds to handling the message flows 603 to 610 of FIG. 6.

During step 800, the base station or gNB 305 receives the multicast session activation notification or message as part of the MBS session activation 512/602 from the core network 102. This step is further detailed in TS 23.247 clause 7.2.5. It includes radio resource reservation by the gNB to allow sending the multicast data on the radio network to reach the UEs.

As part of the session activation procedure, the core network 102 request the gNBs (305, 110, 111) to send paging messages to RRC_INACTIVE UEs that have previously joined the multicast session to notify the UEs that the multicast session has been activated. During step 801, each gNB 305 sends one page or paging message (e.g. paging message 603) which may include a PagingGroupList-r17 field which contains the TMGI (Temporary Mobile Group Identity) of the multicast session that is activated and signalled in 512/602. The TMGI is used as the multicast session id to identify the activated multicast session. The paging cause field (e.g. of the PagingRecord field) of the paging message shall be set to “mbs session activation”. The page message format is defined in TS 38.331 clause 6.2.2 except for the paging cause field that is amended in this example embodiment of the invention to add a new cause field called “mbs session activation”. The gNB shall enter the UE's identities to identify the RRC_INACTIVE UEs that have previously joined the multicast session in the eu_identity fields of the page message.

In an example, a base station or gNB may determine whether the UEs are capable of receiving multicast in RRC_INACTIVE state and if the AF 104 (Application Function) allows the reception of multicast data by UEs in RRC_INACTIVE state. If the gNB determines the UEs are capable of receiving multicast in RRC_INACTIVE state and the AF 104 (Application Function) allows the reception of multicast data by UEs in RRC_INACTIVE state, then the gNB may send a group paging message including an identifier for identifying the activated multicast session (e.g. MBS session id and/or TMGI) and information indicating the multicast session has been activated (e.g. MBS session activation cause information-which indicates the reason for the notification is the activation of the multicast MBS session)—i.e. an enhanced group paging message. Otherwise, if the gNB determines the UEs are not capable of receiving multicast in RRC_INACTIVE state or the AF 104 (Application Function) does not allow the reception of multicast data by UEs in RRC_INACTIVE state, the gNB sends the standard group paging message 513 as defined in FIG. 5b. Both UE and AF capabilities are known at the gNB since the session establishment 523. The gNB might also take into account the UE preference to receive in connected or in non-connected mode (also known at session establishment).

During step 802, the gNB 305 waits for messages from RRC_INACTIVES UEs that are located in the cell served by the gNB 305 and have previously joined the multicast session.

Some UEs may have joined the multicast session while being in another cell, and some others may have joined the multicast session within the gNB's cell but a significant time has passed without refreshing their system information. In both cases, the system information for these UEs will likely be out-of-date (i.e. obsolete) and will need updating. Thus, if a UE determines that its system information needs to be updated, the UE performs a PRACH (Physical Random Access Channel) procedure (yes branch at step 803) to refresh the system information as specified in TS 38.331 clause 5.2.2.3.3. As part of the PRACH procedure, then optionally the gNB 305 may request additional UE context information from neighbouring gNBs (at step 804). The additional context information may include the MBS session join information established in 523. For example, if the UE session join procedure was performed by the UE connected to another gNB, the gNB 305 obtains the MBS session join information, such as the MBS session id, from the another gNB.

Then all concerned UEs (e.g. all RRC_INACTIVE UEs which are located in the cell controlled by the gNB 305 and which have previously joined the multicast session) will send a MBS configuration request message as explained in step 707.

Each time it receives a MBS configuration request message from a UE, the gNB 305 in step 806, prepares a MBS configuration message 609 and sends the MBS configuration message 609 to the requesting UE. In this MBS configuration message, the UE will find the MBS radio bearer configuration parameter to apply in order to the received the multicast data corresponding to the activated MBS session. The details of the MBS radio bearer information element can be found in TS 38.331 clause 6.3.2. It includes PDCP (Packet Data Convergence Protocol) and SDAP (Service DATA Adaptation Protocol) setup information as determined in step 800 when performing the radio resource reservation. The MBS configuration message may also include the MBS session identifier. For example, other fields of the MBS information element like the session identifier are fetched from the memory 325, where they have been stored at session establishment 523 or at UE context fetching 804.

The following provides details of an example procedure for configuring a UE for multicast reception with reference to sections and clauses of TS 38.331 version 17.0.0. The MBSConfigRequest corresponds to the MBS configuration request message discussed above.

The purpose of this procedure is to setup multicast reception in RRC_INACTIVE state, including multicast MRB(s). This procedure is new and shall have a definitive numbering later, for the moment it will be referred to by the number 5.3.X.

### Initiation

The UE initiates the procedure when upper layers or AS (when responding to RAN paging) requests the reception of Multicast in RRC_INACTIVE state.

The UE shall ensure having valid and up to date essential system information as specified in clause 5.2.2.2 before initiating this procedure.

Upon initiation of the procedure, the UE shall:
1> if the resumption of the RRC connection is triggered by response to NG-RAN paging:
   2> select ‘0’ as the Access Category;
   2> perform the unified access control procedure as specified in 5.3.14 using the selected Access Category and one or more Access Identities provided by upper layers;
      3> if the access attempt is barred, the procedure ends;

### Actions Related to Transmission of MBSConfigRequest or MBSConfigRequest1 Message

The UE shall set the contents of MBSConfigRequest or MBSConfigRequest1 message as follows:
1> if field useFullResumeID is signalled in SIBI:
   2> select MBSConfigRequest1 as the message to use;
   2> set the ueIdentity to the stored fullI-RNTI value;
1> else:
   2> select MBSConfigRequest as the message to use;
   2> set the ueIdentity to the stored shortI-RNTI value;
1> re-establish PDCP entities for SRB1;
1> resume SRB1;
1> submit the selected message MBSConfigRequest or MBSConfigRequest1 for transmission to lower layers.

### Reception of the MBSConfiguration by the UE

The UE shall:
1> if the RRCResume includes the radioBearerConfig:
   2> perform the radio bearer configuration according to 5.3.5.6;

### Message Definitions

### MBSConfigRequest

The MBSConfigRequest message is used to request the configuration for the reception of multicast in RRC_INACTIVE state.
Signalling radio bearer: SRB0
RLC-SAP: TM
Logical channel: CCCH
Direction: UE to Network

MBSConfigurationRequest message

| -- ASN1START | |
|---|---|
| -- TAG-MBSCONFIGURATIONREQUEST-START | |
| MBSConfigurationRequest ::= | SEQUENCE { |
| mbsRConfigurationRequest | MBSCconfigurationRequest- |
| IEs | |
| } | |
| MBSConfigurationRequest-IEs ::= | SEQUENCE { |
| ueIdentity | ShortI-RNTI-Value, |
| ueMAC-I | BIT STRING (SIZE (16)), |
| multicastSessionId | MulticastSessionId, |
| spare | BIT STRING (SIZE (1)) |

}
-- TAG-MBSCONFIGURATIONREQUEST-STOP
-- ASN1STOP

MBSConfigurationRequest-IEs field descriptions

multicastSessionId
ueIdentity
UE identity to facilitate UE context retrieval at gNB.
ueMAC-I
Authentication token to facilitate UE authentication at gNB. The 16 least significant bits of
the MAC-I calculated using the AS security configuration as specified in 5.3.13.3.

### MBSConfigurationRequest1

The MBSConfigurationRequest1 message is used to request the configuration for the reception of multicast in RRC_INACTIVE state.
Signalling radio bearer: SRB0
RLC-SAP: TM
Logical channel: CCCH1
Direction: UE to Network

MBSConfigurationRequest1 message

-- ASN1START
-- TAG-MBSCONFIGURATIONREQUEST1-START

| | |
|---|---|
| MBSConfigrationRequest1 ::= | SEQUENCE { |
| mbsConfigurationRequest1 | MBSConfigurationRequest1-IEs |

}

| | |
|---|---|
| MBSConfigurationRequest1-IEs ::= | SEQUENCE { |
| ueIdentity | I-RNTI-Value, |
| ueMAC-I | BIT STRING (SIZE (16)), |
| multicastSessionId | TMGI-R17, |
| spare | BIT STRING (SIZE (1)) |

}
-- TAG-MBSCONFIGURATIONREQUEST1-STOP
-- ASN1STOP

MBSConfigurationRequest1-IEs field descriptions

multicastSessionId
Indicates which MBS session the configuration is requested for.
ueIdentity
UE identity to facilitate UE context retrieval at gNB.
ueMAC-I
Authentication token to facilitate UE authentication at gNB. The 16 least significant bits of
the MAC-I calculated using the AS security configuration as specified in 5.3.13.3.

### MBSConfiguration

The MBSConfiguration message is used to setup the reception of multicast in RRC_INACTIVE state.
Signalling radio bearer: SRB1
RLC-SAP: AM
Logical channel: DCCH
Direction: Network to UE

MBSConfiguration message

| -- ASN1START | |
|---|---|
| -- TAG-MBSCONFIGURE-START | |
| MBSConfigure ::= | SEQUENCE { |
| rrc-TransactionIdentifier | RRC-TransactionIdentifier, |
| criticalExtensions | CHOICE { |
| MBSConfigure | MBSConfigure-IEs, |
| criticalExtensionsFuture | SEQUENCE { } |
| } | |
| } | |
| MBSConfigure-IEs ::= | SEQUENCE { |
| radioBearerConfig | RadioBearerConfig |

OPTIONAL, -- Need M
}
-- TAG-MBSConfigure-STOP
-- ASN1STOP

RRCResume-IEs field descriptions

radioBearerConfig
Configuration of Radio Bearer (MRB) including SDAP/PDCP.

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

1. A method for configuring a User Equipment, UE, of a wireless communication system for multicast reception, the UE having previously joined a multicast session, the method at the UE operating in a non-connected Radio Resource Control, RRC, state comprising:
receiving a notification indicating the multicast session has been activated;
after receiving the notification, sending a request message for requesting configuration information for the reception of multicast data;
receiving a message including configuration information for configuring the UE for reception of multicast data in the non-connected RRC state.

2. The method of claim 1, further comprising configuring the UE for reception of multicast data in a non-connected RRC state based on the configuration information.

3. The method of claim 2, wherein configuring includes performing radio bearer configuration.

4. The method of claim 3, wherein after configuring, receiving data for the multicast session.

5. The method of claim 1, wherein the notification is a paging message.

6. (canceled)

7. The method of claim 1, wherein the notification includes at least one of:
information indicating the multicast session has been activated;
an identifier for identifying the activated multicast session.

8. The method of claim 1, wherein the notification is a group notification.

9. The method of claim 1, wherein the notification is included in a paging message including an identifier for identifying the activated multicast session,
wherein the request message is a RRCResumeRequest message;
wherein the message including configuration information is a RRCRelease message with suspend configuration.

10. (canceled)

11. The method of claim 1, further comprising:
determining based on information included in the notification whether the notification indicates that a multicast session to which the UE has previously joined has been activated,
wherein sending the request message comprises sending the request message in response to determining the notification indicates that a multicast session to which the UE has previously joined has been activated.

12. The method of claim 1, wherein the notification is sent by a base station and the method further comprises performing a random access procedure toward the base station for updating system information of the UE when needed, after receiving the notification.

13. A method at a base station controlling a cell on which one or more User Equipment, UE, are camping, the method comprising:
sending a notification indicating a multicast session has been activated,
after sending the notification, receiving, from at least one of the one or more UE which is operating in a non-connected RRC state and which has previously joined the multicast session, a request message for requesting configuration information for the reception of multicast data;
sending, to the at least one of the one or more UE, in response to the received request message, a message including configuration information for configuring the at least one UE for reception of multicast data in the non-connected RRC state.

14. The method of claim 13, wherein the notification is a paging message.

15. (canceled)

16. The method of claim 13, wherein the notification includes at least one of:
information indicating the multicast session has been activated;
an identifier for identifying the activated multicast session.

17. The method of claim 13, wherein the notification is a group notification.

18. The method of claim 13, wherein the notification is included in a paging message including an identifier for identifying the activated multicast session,
wherein the request message is a RRCResumeRequest message;
wherein the message including configuration information is a RRCRelease message with suspend configuration.

19. (canceled)

20. The method of claim 13, wherein the non-connected RRC state is a RRC_INACTIVE state.

21-23. (canceled)

24. The method of claim 13, wherein the configuration information includes configuration information of at least one MBS Radio Bearer, MRB.

25. Apparatus for a User Equipment, UE, comprising:
one or more processors configured to:
receive a notification indicating a multicast session, which the UE has previously joined, has been activated;
after receiving the notification, send a request message for requesting configuration information for the reception of multicast data;
receive a message including configuration information for configuring the UE for reception of multicast data in the non-connected RRC state.

26. Apparatus for a base station comprising:
one or more processors configured to:
send a notification indicating a multicast session has been activated,
after sending the notification, receive, from at least one of one or more UE which is operating in a non-connected RRC state and which has previously joined the multicast session, a request message for requesting configuration information for the reception of multicast data;
send, to the at least one of the one or more UE, in response to the received request message, a message including configuration information for configuring the at least one UE for reception of multicast data in the non-connected RRC state.

27. (canceled)

28. A non-transitory computer-readable storage medium carrying a computer program comprising instructions, which when the program is executed by one or more processors of a User Equipment, UE, cause the UE to:
receive a notification indicating a multicast session, which the UE has previously joined, has been activated;
after receiving the notification, send a request message for requesting configuration information for the reception of multicast data;
receive a message including configuration information for configuring the UE for reception of multicast data in the non-connected RRC state.

29. The method of claim 1, wherein the non-connected RRC state is a RRC_INACTIVE state.

30. The method of claim 1, wherein the configuration information includes configuration information of at least one MBS Radio Bearer, MRB.

31. The apparatus of claim 25, wherein the one or more processors are further configured to configure the UE for reception of multicast data in a non-connected RRC state based on the configuration information.

32. The apparatus of claim 25, wherein the notification is a paging message.

33. The apparatus of claim 25, wherein the notification includes at least one of:
information indicating the multicast session has been activated;
an identifier for identifying the activated multicast session.

34. The apparatus of claim 25, wherein the notification is a group notification.

35. The apparatus of claim 25, wherein the notification is included in a paging message including an identifier for identifying the activated multicast session,
wherein the request message is a RRCResumeRequest message;
wherein the message including configuration information is a RRCRelease message with suspend configuration.

36. The apparatus of claim 25, wherein the notification is sent by a base station and the one or more processors are further configured to perform a random access procedure toward the base station for updating system information of the UE when needed, after receiving the notification.

37. The apparatus of claim 25, wherein the non-connected RRC state is a RRC_INACTIVE state.

38. The apparatus of claim 25, wherein the configuration information includes configuration information of at least one MBS Radio Bearer, MRB.

39. The apparatus of claim 26, wherein the notification is a paging message.

40. The apparatus of claim 26, wherein the notification includes at least one of:
information indicating the multicast session has been activated;
an identifier for identifying the activated multicast session.

41. The apparatus of claim 26, wherein the notification is a group notification.

42. The apparatus of claim 26, wherein the notification is included in a paging message including an identifier for identifying the activated multicast session,
wherein the request message is a RRCResumeRequest message;
wherein the message including configuration information is a RRCRelease message with suspend configuration.

43. The apparatus of claim 26, wherein the non-connected RRC state is a RRC_INACTIVE state.

44. The apparatus of claim 26, wherein the configuration information includes configuration information of at least one MBS Radio Bearer, MRB.
